(19) United States
(12) Patent Application Publication
(10) Pub. No.: US 2024/0094726 A1
(43) Pub. Date: Mar. 21, 2024

(54) VERIFYING FLIGHT SYSTEM CALIBRATION AND PERFORMING AUTOMATED NAVIGATION ACTIONS

(71) Applicant: Reliable Robotics Corporation, Mountain View, CA (US)

(72) Inventors: Sydney Michelle Katz, South San Francisco, CA (US); Matthew Thomas Nehrenz, Campbell, CA (US); Prasenjit Sengupta, Mountain View, CA (US)

(21) Appl. No.: 18/369,713

(22) Filed: Sep. 18, 2023

Related U.S. Application Data
(60) Provisional application No. 63/376,061, filed on Sep. 16, 2022.

(51) Int. Cl. G05D 1/00; B64D 47/08; G05D 1/10; G06V 10/774; G06V 20/10; G06V 20/17

(52) U.S. Cl. CPC G05D 1/0055; B64D 47/08; G05D 1/106; G06V 10/774; G06V 20/17; G06V 20/176

(57) ABSTRACT

A system having components coupled to an aircraft that measure the navigational state and state uncertainty of an aircraft. To do so, the aircraft captures an image of its surrounding environment including an object of interest and applies one or more machine vision models to the image. One or more of the models determine if the image is acceptable, in that it determines if an object of interest is represented in the image. One or more of the models determine a calibrated uncertainty based on information extracted previously labelled images and current measurements of navigational state and uncertainty. One or more of the models determine a protection level for the aircraft and determines an operational system of the aircraft is available to perform a navigational action based on the protection level (e.g., by comparing protection level to an alert level).

### CROSS-REFERENCE TO RELATED APPLICATIONS

This application claims priority to U.S. Provisional Application Ser. No. 63/376,061 filed Sep. 16, 2022, which is incorporated by reference in its entirety.

### TECHNICAL FIELD

This disclosure relates generally to navigation systems, and more specifically to systems and methods for determining whether an operational system is available during flight of an aircraft based on its calibration.

### BACKGROUND

Successful aerial navigation requires that the stated (e.g., position, orientation, motion, etc.) of an aircraft be known to a high degree of certainty at all times. Recently, given the advent of autonomous and semi-autonomous flight systems, there has been an increased emphasis on developing and implementing machine learning systems to determine and verify the state of aircrafts and use the determined states during operation. However, current systems for automated navigation that operate onboard an aircraft (and/or are remote from the aircraft) require installation and maintenance of expensive apparatuses, lack a high degree of precision, are largely unreliable, drift in accuracy, and/or are prone to interference. As such, there is a need to develop systems and methods for determining the accuracy of an aircraft using navigational systems in a manner that does not introduce or reinforce these problems.

### SUMMARY

In some aspects, the techniques described herein relate to a method including: accessing an image of an environment surrounding an aerial vehicle, the image including latent pixel information; applying a state recognition model to the image to determine whether the image represents a location of interest, the state recognition model configured to: determine a navigational state of the aerial vehicle using latent pixel information of the image, determine an uncertainty of the navigational state using latent pixel information of the image, generate a reconstructed image using the navigational state and the uncertainty, and compare the image to the reconstructed image to determine whether the image represents the location of interest; responsive to determining the image represents the location of interest, applying a protection model to the image to determine a protection level for the aerial vehicle based on the uncertainty; and performing, with the aerial vehicle, a navigation action based on the navigational state when the protection level is below a threshold protection level.

In some aspects, the techniques described herein relate to a method, wherein the latent pixel information includes information representing the location of interest, the navigational state of the aerial vehicle, and the uncertainty of the navigational state.

In some aspects, the techniques described herein relate to a method, wherein determining the image represents the location of interest with the state recognition model further includes: identifying additional latent variables representing the location of interest using the latent pixel information; wherein generating the reconstructed image additionally uses the additional latent variables.

In some aspects, the techniques described herein relate to a method, wherein comparing the image to the reconstructed image includes calculating a distance metric quantifying differences between the image and the reconstructed image. In some aspects, the techniques described herein relate to a method, wherein accessing the image of the environment includes: capturing an image of the environment using an camera system of the aerial vehicle.

In some aspects, the techniques described herein relate to a method, wherein determining the protection level using the protection model includes: calibrating an actual uncertainty based on the uncertainty and a range of acceptable uncertainties, the range of acceptable uncertainties previously calculated from a plurality of acceptable images.

In some aspects, the techniques described herein relate to a method, wherein the location of interest includes any one of: a runway, a landing pad, a dynamic object surrounding the aerial vehicle, and a static object surrounding the aerial vehicle. In some aspects, the techniques described herein relate to a method, wherein the runway includes one or more of: an approach light system, a runway threshold, runway threshold markings, runway end identifier lights, a slope indicator, a touchdown zone, touchdown zone lights, runway markings, and runway lights.

In some aspects, the techniques described herein relate to a method, wherein the aerial vehicle includes any one of: an autonomously controlled aerial vehicle, a semi-autonomously controlled aerial vehicle, a remote-controlled aerial vehicle, a drone, a helicopter, a glider, a rotorcraft, a lighter than air vehicle, a powered lift vehicle, and an airplane. In some aspects, the techniques described herein relate to a method, wherein the threshold protection level is implemented by a system designer of the protection model.

In some aspects, the techniques described herein relate to a method, wherein each protection level corresponds to a range of uncertainties for the navigational state. In some aspects, the techniques described herein relate to a method, wherein the determined uncertainty is an aleatoric uncertainty.

In some aspects, the techniques described herein relate to a method, wherein the protection level is associated with a system of the aerial vehicle, and the system performs the navigation action. In some aspects, the techniques described herein relate to a method, wherein the state recognition model is trained using a plurality of training images, the plurality of training images including real images, simulated images, or a combination of real and simulated images.

In some aspects, the techniques described herein relate to a method, wherein each training image of the plurality includes latent pixel information representing a similar location of interest and an acceptable navigational state and an acceptable uncertainty of the navigational state. In some aspects, the techniques described herein relate to a method, wherein each protection level corresponds to a range of uncertainties for the navigational state. In some aspects, the techniques described herein relate to a method, wherein the determined uncertainty is an aleatoric uncertainty. In some aspects, the techniques described herein relate to a method, wherein the protection level is associated with a system of the aerial vehicle, and the system performs the navigation action.

In some aspects, the techniques described herein relate to a method including: at a computer system including a processor and a computer-readable medium: accessing an image of an environment surrounding an aerial vehicle, the image including latent pixel information; applying a state recognition model to the image to determine whether the image represents a location of interest, the state recognition model configured to: determine a navigational state of the aerial vehicle using latent pixel information of the image, determine an uncertainty of the navigational state using latent pixel information of the image, generate a reconstructed image using the navigational state and the uncertainty, and compare the image to the reconstructed image to determine whether the image represents the location of interest; responsive to determining the image represents the location of interest, applying a protection model to the image to determine a protection level for the aerial vehicle based on the uncertainty; and performing, with the aerial vehicle, a navigation action based on the navigational state when the protection level is below a threshold protection level.

In some aspects, the techniques described herein relate to a non-transitory, computer-readable medium storing instructions that, when executed by a processor, cause the processor to: access an image of an environment surrounding an aerial vehicle, the image including latent pixel information; apply a state recognition model to the image to determine whether the image represents a location of interest, the state recognition model configured to: determine a navigational state of the aerial vehicle using latent pixel information of the image, determine an uncertainty of the navigational state using latent pixel information of the image, generate a reconstructed image using the navigational state and the uncertainty, and compare the image to the reconstructed image to determine whether the image represents the location of interest; responsive to determine the image represents the location of interest, applying a protection model to the image to determine a protection level for the aerial vehicle based on the uncertainty; and perform with the aerial vehicle, a navigation action based on the navigational state when the protection level is below a threshold protection level.

### BRIEF DESCRIPTION OF THE DRAWINGS

FIG. 1A depicts a schematic of a system for determining a navigational state and corresponding uncertainty, according to an example embodiment.

FIG. 1B is a block diagram representing the machine vision subsystem, according to an example embodiment.

FIG. 2 illustrates a workflow diagram of determining a navigational action based on an accessed image, according to one example embodiment.

FIG. 3A-3D illustrates various locations of interest, according to several example embodiments.

FIG. 4 shows an example workflow of a state recognition model, according to an example embodiment.

FIG. 5A illustrates a comparison of a reconstructed image to its corresponding accessed image that results in an acceptable reconstructed image, according to an example embodiment.

FIG. 5B illustrates a comparison of a reconstructed image to its corresponding accessed image which results in an unacceptable reconstructed image, according to an example embodiment.

FIG. 6 depicts a workflow of a protection level model, according to an example embodiment.

FIG. 7 illustrates a representation of an autoencoder model, according to an example embodiment.

FIG. 8 is a block diagram illustrating components of an example machine for reading and executing instructions from a machine-readable medium, according to an example embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### Introduction

Navigational accuracy in aviation is critical because various flight systems rely heavily on, e.g., accurate position, timing, and velocity data for flight safety. Moreover, the flight systems further use that data for optimizing flight operations and reducing fuel expenditure. Given its robust importance, accurately measuring the state (e.g., position, speed, etc.) of an aerial vehicle and the uncertainty of that measured state is important in designing and implementing flight systems for safe autonomous and semi-autonomous aerial vehicles.

There are many traditional ways to measure the accuracy and uncertainty of an aircraft's state. For example, a navigational state may be measured by a satellite system, a radar system, etc. However, as machine learning systems that aid navigation integrate into traditional aerial vehicle systems, the needs for measuring both state and uncertainty have changed.

To illustrate, for instance, consider an aerial vehicle employing a traditional Global Positioning System (“GPS”) system to aid in measuring the plane's navigational state and taking appropriate actions. In this case, a GPS system may have built-in, traditional methods for determining position and its corresponding positional uncertainty that may affect how the aerial vehicle is operated. For example, GPS may provide the aircraft with its measured position and positional uncertainty, and the aircraft may take actions based on those positions and uncertainties (e.g., navigating the route determined by an autopilot).

Now consider an aerial vehicle that employs both a GPS system and a computer-vision machine-learning model to aid in its navigation. The computer-vision machine learning model may, for example, take an image of an environment surrounding the aircraft and estimate the aircraft's relative position and corresponding uncertainty based on objects in the image. The aircraft may also take the appropriate actions (e.g., landing an aircraft) based on these estimations. Now, in some instances, the GPS system may provide a determination of position with low uncertainty (i.e., a precise and/or accurate measurement of position), but the computer-vision model may provide a determination of position with high uncertainty (i.e., an imprecise and/or inaccurate measurement of position). When this occurs, there is some question as to whether the position determination from the GPS system and/or the position determination from the computer-vision model is sufficiently accurate to allow the plane to take specific navigational actions (e.g., autonomously or semi-autonomously).

As such, there is a need to reconcile the various forms of navigational measurements and their corresponding uncertainty (e.g., reconciling a traditional GPS based position measurement and its uncertainty with a computer-vision based position measurement and its uncertainty) such that aerial vehicles can safely perform actions based on those measurements. The systems and methods described hereinbelow allow for an aerial vehicle to safely manage navigational measurements and uncertainty from a computer-vision machine-learning model.

### II. System

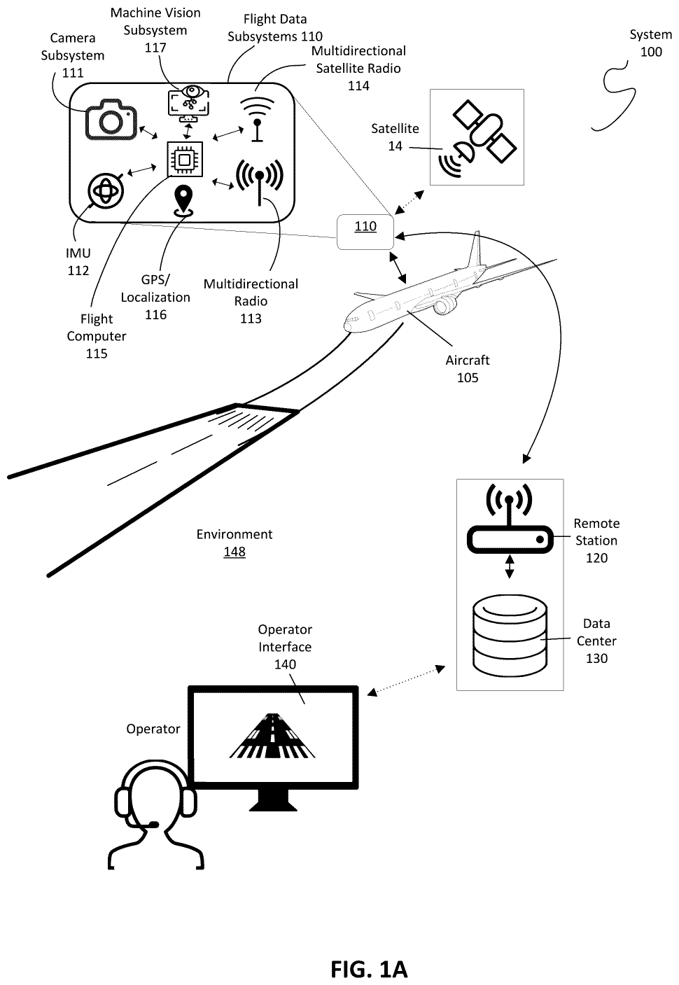

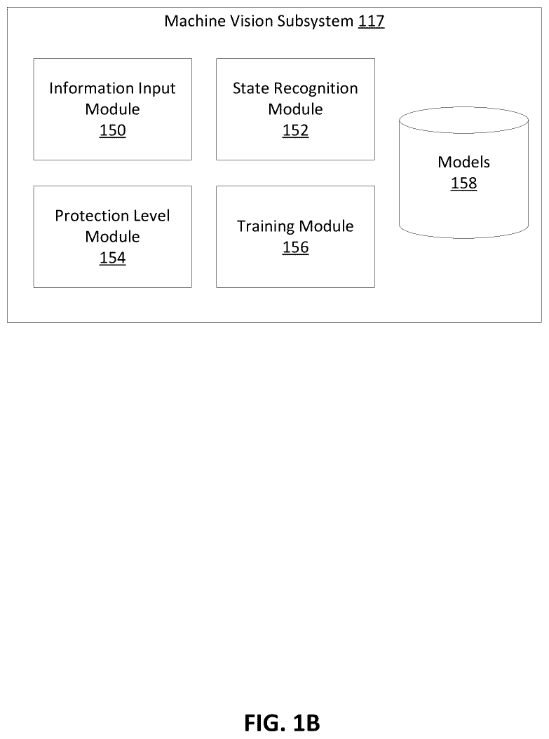

FIG. 1A depicts a schematic of a system for determining a navigational state and corresponding uncertainty, according to an example embodiment. The system 100 includes one or more flight data subsystems 110 coupled to (e.g., mounted to, onboard, within, etc.) an aircraft 105, a remote station 120 in communication with a data center 130 at a location remote from the aircraft 105, and an operator interface 140 in communication with the remote station 120 by way of the data center 130. The system 100 provides structures, subsystem interfaces, and operation modes useful for implementation of automated flight operations, including operations associated with methods described in more detail in Section 1 below.

### II.A System—Aircraft

The aircraft 105 shown in FIG. 1A is a fixed-wing aircraft. The aircraft has flight control surfaces for aerodynamically affecting flight of the aircraft relative to a pitch axis (i.e., a transverse axis), a yaw axis (i.e., a vertical axis), and a roll axis (i.e., longitudinal axis) of the aircraft. Flight control surfaces can include one or more of: ailerons, flaps, elevators, stabilizers (e.g., horizontal stabilizers), rudders, spoilers, slats, air brakes, vortex generators, trim surfaces, and any other suitable control surfaces. The aircraft also has a power plant for generation of mechanical power associated with flight operations, and in variations, the power plant can include one or more of: a piston engine (e.g., in-line engine, V-type engine, opposed engine, radial engine, etc.), a gas turbine engine (e.g., turbojet engine, turbofan engine), a pulse jet, a rocket, a Wankel engine, a Diesel engine, an electric engine, a hybrid engine, and any other suitable power plant system. The power plant is coupled to an energy source (e.g., fuel system, battery, solar cell, etc.) and a cooling system (e.g., forced convection cooling system, liquid cooling system, oil cooling system, etc.) for aircraft performance in flight.

While this description uses a fixed-wing aircraft as an example, the principles described herein are equally applicable to variations of the aircraft 105 including form factors and/or control surfaces associated with one or more of: rotorcraft, gliders, lighter-than-air aircraft (e.g., airships, balloons), powered-lift aircraft, powered-parachute aircraft, weight-shift-control aircraft, rockets, airplanes, drones, remote-controlled aerial vehicles, and/or any other suitable types of aircraft. Still other variations of the system 100 can involve terrestrial vehicles, water vehicles, amphibious vehicles, or other non-aircraft vehicles. In other examples, the aerial vehicle may be an autonomously controlled aerial vehicle, a semi-autonomously controlled aerial vehicle, a remote-controlled aerial vehicle, a drone, a helicopter, a glider, a rotorcraft, a lighter than air vehicle, a powered lift vehicle, or an airplane.

### II.B System—Flight Data Subsystems

The flight data subsystems 110 include subsystems capable of generating data associated with dynamic states of the aircraft, environments about the aircraft, operation states of aircraft systems (e.g., power plant systems, energy systems, electrical systems, etc.), and any other suitable systems associated with operations of the aircraft on the ground or in flight. The flight data subsystems 110 also include subsystems capable of transmitting data to and from the aircraft 105 and other remote systems.

As such, the flight data subsystems 110 include subsystems that generate and receive information generated from subsystems coupled to the aircraft 105, as well as a flight computer 115 providing computational infrastructure (e.g., processing components, communication buses, memory, etc.) for communicating data between the subsystems. The flight computer 115 thus provides architecture for communication of data generated by subsystems, for communication with other systems remote from the aircraft 105, for control of subsystems, and/or for control of the aircraft. The flight data subsystems 110 can thus include specialized computer components designed for use in an aircraft, and in particular, can include components that are customized in configuration relative to each other and customized in relation to processing of signals received and processed to perform aspects of the methods described in Section 2.1 below.

### II.B.1 System—Flight Data Subsystems—Camera and IMU Components

As shown in FIG. 1A, the flight data subsystems 110 include a camera subsystem 111 mounted to the aircraft, where the camera subsystem 111 includes sensors configured to capture features of the landing site, features of objects in the vicinity of the landing site, features of calibration objects along a path of operation of the aircraft, features of other objects along a path of operation of the aircraft, and/or any other suitable object aspects to facilitate automated landing of the aircraft at a desired landing site. More simply, the camera subsystem 111 is configured to capture images comprising pixels that include information describing various locations and objects of interest in the environment surrounding the aircraft 105.

Sensors of the camera subsystem 111 can utilize the visible spectrum. Sensors of the camera subsystem 111 can additionally or alternatively include longwave infrared (LWIR) sensors (e.g., sensors operating in the 8-12 μm band). The camera subsystem 111 can also include optical elements (e.g., lenses, filters, mirrors, apertures etc.) for manipulating light reaching the sensors of the camera subsystem 111. In relation to detection of airport lighting systems for landing site localization relative to airport lighting, the camera subsystem 111 can include one or more filters optically coupled to the sensors and configured to detect spectra of light emitted from airfield landing systems (e.g., lighting systems in accordance with Federal Aviation Administration Advisory Circular 150/5345-46E). Variations of the camera subsystem 111 can, however, have any other suitable sensor types and/or optical elements associated with visible spectra and/or non-visible spectra electromagnetic radiation.

The camera subsystem 111 can have one or more cameras structurally mounted to the aircraft and positioned so as to enable detection of the landing site, objects of interest, locations of interest, or other site relevant to operation of the aircraft, as the aircraft traverses through space. Multiple cameras can be used for system redundancy (e.g., in the event a subset of cameras have occluded optical elements) and/or for providing different field of view options depending on approach path and orientation to a landing site. The camera(s) of the camera subsystem 111 can be coupled to an interior portion of the aircraft 105 or can be coupled to an exterior portion of the aircraft 105. Mounting positions are associated with desired flight paths to a landing site (e.g., approach patterns, instructions from air traffic control, etc.). As such, the camera subsystem 111 can have a camera that has a field of view of at least 270 degrees about the aircraft 105. The camera subsystem 111 can additionally or alternatively have a first camera mounted toward a port side of the aircraft (e.g., for left traffic operations), a second camera mounted toward a starboard side of the aircraft (e.g., for right traffic operations), a third camera mounted toward a nose portion of the aircraft (e.g., for straight-in approaches), and/or any other suitable cameras mounted at any other suitable portion of the aircraft 105.

The camera(s) of the camera subsystem 111 can thus be fixed in position. The camera(s) of the camera subsystem 111 can alternatively be adjustable in position based on flight paths of the aircraft 105 to the landing site. The camera subsystem 111 can thus include actuators coupled to the camera(s) of the camera subsystem 111 and/or position encoders coupled to the actuators, in relation to electronic control of camera positions. In relation to image stabilization, the camera(s) of the camera subsystem 111 can be coupled to image stabilization subsystems (e.g., gimbals) to reduce artifacts due to vibration or other undesired image artifacts that would otherwise be included in image data generated from the camera subsystems 111.

The camera subsystem 111 captures images of the operational environment 148 surrounding the aircraft. The operational environment may include potential environmental factors, conditions, or circumstances that influence the planning and execution of the aircraft operation]. For instance, the operational environment 148 may include locations of interest and/or objects of interest. A location of interest is a specific geographical area or altitudinal position(s). For example, a location of interest may be a runway, a helicopter pad, or a no-fly zone. A location of interest can be any other static or dynamic object in the environment. An object of interest is any object that may influence the navigational actions an aircraft may take. For example, an object of interest may be runway boundary markers, or a nearby aircraft, an approach light system, a runway threshold, runway threshold markings, runway end identifier lights, a slope indicator, a touchdown zone, touchdown zone lights, runway markings, and runway lights. An object of interest may also be any other static or dynamic object in the environment. Additionally, the operational environment 148 may include, e.g., static objects and dynamic objects. Static objects may include runways, landing sites, and runway boundary markers. Dynamic objects may include a plane, a drone, an aerial vehicle, and a hot air balloon.

The camera subsystem 111 produces output images that have a characteristic resolution (e.g., associated with a sensor size), focal length, aspect ratio, and/or directionality (e.g., unidirectionality associated with 360 degree images), format color model, depth, and/or other aspects. The camera subsystem 111 can be configured for one or more of: monoscopic images, stereoscopic images, panoramic images, and/or any other suitable type of image output. Furthermore, while images are described, the camera subsystem 111 can be configured to output video data.

The flight data subsystem 110 also includes one or more inertial measurement units (IMUs) 112 for measuring and outputting data associated with the aircraft's specific force, angular rate, magnetic field surrounding the aircraft 105, and/or other position, velocity, and acceleration-associated data. Outputs of the IMU can be processed with outputs of other aircraft subsystem outputs to determine poses of the aircraft 105 relative to a landing site (or other target), and/or pose trajectories of the aircraft 105 relative to a landing site (or other target). The IMU 112 includes one or more accelerometers, one or more gyroscopes, and can include one or more magnetometers, where any or all of the accelerometer(s), gyroscope(s), and magnetometer(s) can be associated with a pitch axis, a yaw axis, and a roll axis of the aircraft 105.

The IMUs 112 are coupled to the aircraft and can be positioned internal to the aircraft or mounted to an exterior portion of the aircraft. In relation to measurement facilitation and/or post-processing of data form the IMU, the IMU can be coupled to a vibration dampener for mitigation of data artifacts from sources of vibration (e.g., engine vibration) or other undesired signal components.

Additionally or alternatively, the system 100 can include a radar subsystem that operates to detect radar responsive (e.g., reflective, scattering, absorbing, etc.) objects positioned relative to a flight path of the aircraft 105 (e.g., below the aircraft 105), in order to facilitate determination of pose or state of the aircraft 105 in supplementing methods described below. Additionally or alternatively, the system can include a light emitting subsystem that operates to detect light responsive (e.g., reflective, scattering, absorbing, etc.) objects positioned relative to a flight path of the aircraft 105 (e.g., below the aircraft 105), in order to facilitate determination of pose or state of the aircraft 105 in supplementing methods described below.

### II.B.2 System—Flight Data Subsystems—Communication Components

The flight data subsystem 110 also includes a radio transmission subsystem 113 for communication with the aircraft 105, for transmission of aircraft identification information, or for transmission of other signals. The radio transmission subsystem 113 can include one or more multidirectional radios (e.g., bi-directional radios) onboard the aircraft, with antennas mounted to the aircraft in a manner that reduces signal transmission interference (e.g., through other structures of the aircraft). The radios of the radio transmission subsystem 113 operate in approved frequency bands (e.g., bands approved through Federal Communications Commission regulations, bands approved through Federal Aviation Administration advisory circulars, etc.).

The flight data subsystem 110 can also include a satellite transmission subsystem 114 for interfacing with one or more satellites including satellite 14. The satellite transmission subsystem 114 transmits and/or receives satellite data for navigation purposes (e.g., on a scale associated with less precision than that used for landing at a landing site), for traffic avoidance in coordination with automatic dependent surveillance broadcast (ADS-B) functionality, for weather services (e.g., in relation to weather along flight path, in relation to winds aloft, in relation to wind on the ground, etc.), for flight information (e.g., associated with flight restrictions, for notices, etc.), and/or for any other suitable purpose. The satellite transmission subsystem 114 operates in approved frequency bands (e.g., bands approved through Federal Communications Commission regulations, bands approved through Federal Aviation Administration advisory circulars, etc.).

The communication-related components of the flight data subsystems 110 can additionally or alternatively cooperate with or supplement data from other avionics components (e.g., a global positioning system and/or other localization subsystem), electrical components (e.g., lights), and/or sensors that support flight operations (e.g., in flight, during landing, on the ground, etc.), that support observability by other traffic, that support observability by other aircraft detection systems, that provide environmental information (e.g., pressure information, moisture information, visibility information, etc.) and/or perform other functions related to aircraft communications and observability.

### II.B.3 System—Flight Data Subsystems—Machine Vision Algorithms

The flight data subsystem 110 also includes a machine vision subsystem 117. The machine vision subsystem 117 uses inputs from various other flight data subsystems (e.g., camera subsystem 111, IMU 112, GPS 116, and flight computer 115) to determine, e.g., a navigational state of the aircraft and an uncertainty for the navigational state. The machine vision subsystem is described in greater detail in regard to FIG. 1B.

### II.B.4 System—Remote Components

As shown in FIG. 1A, the system 100 also includes a remote station 120 that includes devices for wirelessly receiving data from and transmitting data to subsystems coupled to the aircraft. The remote station 120 includes one or more multidirectional radios (e.g., bi-directional radios) onboard the aircraft, with antennas mounted to the aircraft in a manner that reduces signal transmission interference (e.g., through other structures of the aircraft). The radios of the remote station operate in approved frequency bands (e.g., bands approved through Federal Communications Commission regulations, bands approved through Federal Aviation Administration advisory circulars, etc.). The remote station 120 is in communication with a data center 130 for storage and retrieval of data derived from subsystems of the aircraft 105 and/or outputs from the operator interface 140 described in more detail below. The data center uses storage and retrieval protocols and can use data encryption protocols for promoting security in relation to handling sensitive information pertaining to autonomous flight of the aircraft 105.

The remote station 120 can also use communications technologies and/or protocols in relation to data transmission operations with the data center 130, subsystems of the aircraft 105, and/or the operator interface 140 described in more detail below. For example, the remote station 120 can have communication links using technologies such as Ethernet, 802.11, worldwide interoperability for microwave access (WiMAX), 3G, 4G, code division multiple access (CDMA), digital subscriber line (DSL), or other communication technologies. Examples of networking protocols used for communications with the remote station 120 include user datagram protocol (UDP) and/or any other suitable protocol. Data exchanged with the remote station 120 can be represented using any suitable format.

As shown in FIG. 1A, the system 100 also includes an operator interface 140. The operator interface 140 receives processed data (e.g., image data) generated from the subsystems of the aircraft 105, provides representations of processed data to an operator or other entity (e.g., through a display), and receives inputs provided by the operator or other entity in response to provided representations of processed data. The operator interface 140 can include a conventional computer system, such as a desktop or laptop computer. Additionally or alternatively, the operator interface 140 can include a device having computer functionality, such as a personal digital assistant (PDA), a mobile telephone, a smartphone, a wearable computing device (e.g., a wrist-borne wearable computing device, a head-mounted wearable computing device, etc.), or another suitable device. The operator interface 140 is electronically coupled to the remote station 120 and/or the data center 130 by any combination of local area and/or wide area networks, using transmission and storage protocols, as described above, and can use both wired and/or wireless communication systems.

Further, while the system(s) described above can implement embodiments, variations, and/or examples of the method(s) described below, the system(s) can additionally or alternatively implement any other suitable method(s).

### III. Machine Vision Subsystem

The flight data subsystem 110 includes a machine vision subsystem 117. FIG. 1B is a block diagram representing the machine vision subsystem, according to an example embodiment. The machine vision subsystem 117 inputs images of an environment surrounding the aircraft, determines whether the image of the environment represents a location of interest, determines a navigational state and uncertainty of the aircraft based on the image, and determines whether performance of a navigational action is safe based on those determinations. In other words, the machine vision subsystem 117 enables the aircraft to capture, process, and interpret real world images (in conjunction with other measurements taken by the flight data subsystems) to safely perform navigational actions. To that end, the machine vision subsystem 117 extracts relevant information (e.g., navigational state and uncertainty) from the image and makes decisions based on that information to facilitate safe flight operations.

The machine vision subsystem 117 (“MVS 117”) includes an information input module 150, a state recognition module 152, a protection level module 154, a training module 156 and several models 158. The machine vision subsystem 117 can include additional or fewer modules and models with varying functionality, and the functionality of the modules and models within the machine vision subsystem 117 can be attributable to modules in a manner other than those described herein. For instance, all or some of the functionality of the information input module 150 may be included in the state recognition module 152 and/or the protection level module 154. Furthermore, the machine vision subsystem 117 can implement embodiments, variations, and/or examples of the method(s) described below, and the machine vision subsystem 117 can additionally or alternatively implement any other suitable method(s).

The MVS 117 utilizes the information input module (“IIM”) 150 to input information from the aircraft (e.g., aircraft 105) and/or other flight data subsystems 110. For example, the IIM 150 may input an image of the environment 148 from the camera subsystem 111, inertial information from the IMU 112, and/or positional data from the GPS 116. Notably, these are just examples, and the IIM 150 may input any other data to enable the MVS 117 to perform its functionality.

The MVS 117 utilizes the state recognition model (“SRM”) 152 to determine a navigational state and state uncertainty. A navigational state is a description of, e.g., an aircraft's position, orientation, direction, and/or movement, etc. The navigational state may be described with respect to an environment, as a relative value, or as an absolute value within a coordinate system. As an example, a navigational state may include, e.g., an aircraft's current position in relation to a runway when taxiing from or landing on a runway, or an aircraft's current position relative to a flight path. A state uncertainty is a quantification of an uncertainty of the navigational state. That is, the state uncertainty is a measure of how “unsure” the MVS 117 is in determining the navigational state. For instance, the state uncertainty may be a quantification of an error between an estimated state position (e.g., derived from an image) and the actual state position (e.g., as measured from an aircraft's instruments). Some example state uncertainties may include potential errors from sensors measuring navigational state (e.g., altitude, velocity, etc.), or estimates of a navigational state derived from those measurements (e.g., a relative position as derived from an image). State uncertainty may be calculated and quantified in a variety of manners. For instance, state uncertainty may be calculated as, e.g., a statistical variance, an aleatoric uncertainty, etc. Additionally, the state uncertainty may be quantified as, e.g., an absolute error, a relative error, a standard deviation, etc.

The MVS 117 utilizes the protection level module (“PLM”) 154 to determine a protection level for measurements and estimates made by an aircraft. A protection level is a statistical bound on an estimated quantity such as, e.g., a navigational state or a state uncertainty. More plainly, the protection level defines an “error” for an aircraft's, e.g., position measurement or estimate. For example, a GPS system with Wide Area Augmentation System (WAAS) corrections produces 1e-7 protection levels. This indicates that the true error of the measured GPS coordinates is contained within the protection level with a probability of 1-1×10⁻⁷. To further contextualize, the error may be less than 5 meters with a probability of 1-1×10⁻⁷, or the error may be larger than 5 m with a probability of 1×10⁻⁷.

Protection levels may be used in determining whether particular navigation actions based on those measurements and estimates are safe. For instance, if a protection level is numerically high (i.e., has higher error) the aircraft is less sure about a measurement or estimate and a particular navigation action based on that protection level may be less safe to conduct. Conversely, if a protection level is numerically low (i.e., has less error) the aircraft is surer about a measurement or estimate and a particular navigation action based on the protection level may be safer to conduct.

With this context, the PLM 154 determines whether an operational system (e.g., an automatic landing system) of the aircraft 105 is available based on the determined protection level relative to an alert limit. An available operational system is one that an aircraft system can safely employ based on the available measurements of navigational state and state uncertainty. An alert limit is a quantification of what level of error and/or uncertainty (e.g., protection level) renders a subsequent action based on those measurements or estimations unsafe to implement. Thus, in plainer language, an alert limit is a value that corresponds to “safe” versus “unsafe” implementation of operational systems in taking navigational actions. As such, the PLM 154 determines an operational system of an aircraft is available if the determined protection level is below the alert limit, and determines the operational system is unavailable if the determined protection level is above the alert limit.

The PLM 154 determines a navigational action to perform based on the determined availability of the operational system. If the operational system is available, the PLM 154 may determine to perform a navigational action with that operational system, and, conversely, if the operational system is unavailable, the PLM 154 may determine not to perform a navigational action with that operational system. A navigational action is an aircraft operation based on a determined navigational state that employs the operational system. Some example navigational actions may include, e.g., landing an aircraft on a runway based on a determined position of the aircraft relative to the runway, directing an aircraft away from air traffic based on a determined velocity of the aircraft, navigating an aircraft during taxiing, navigating an aircraft during takeoff, etc.

### IV Using Machine Vision Subsystems to Perform Navigation Actions

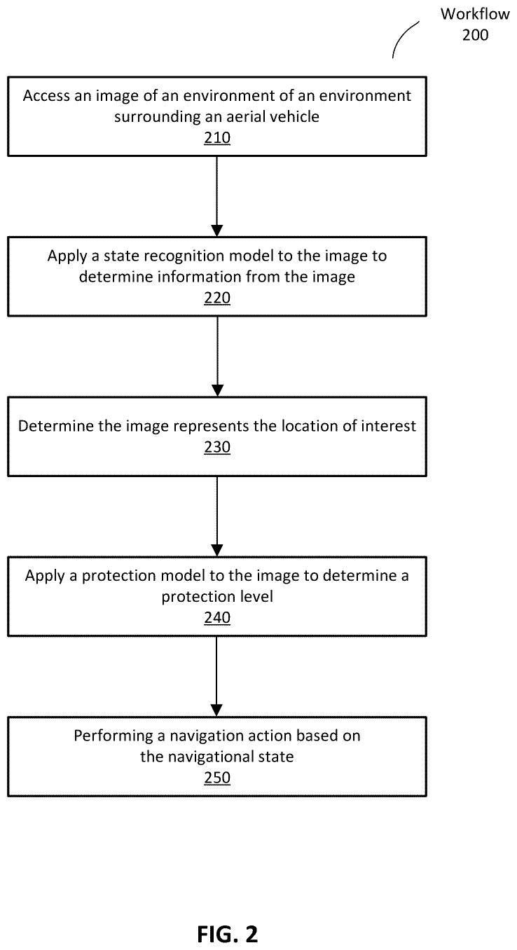

To illustrate the functionality of the MVS 117, FIG. 2 illustrates a workflow diagram of determining a navigational action based on an accessed image, according to one example embodiment. In the illustrated workflow 200, the MVS 117 and its subsystems (e.g., IIM 150, SRM 152, and PLM 154) may perform additional or fewer actions, the actions may be performed in a different order, and/or one or more of the actions may be repeated or not performed.

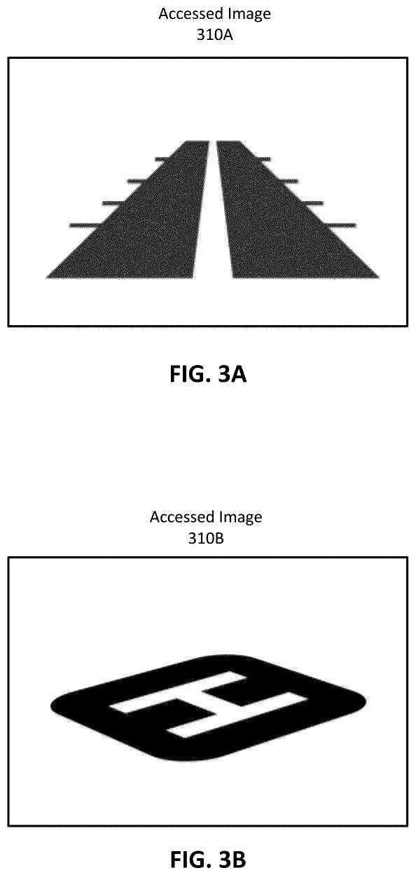

The MVS 117 accesses 210 system information (e.g., images, GPS measurements, IMU measurements, etc.) from the flight data subsystems (e.g., subsystems 110). To illustrate, turning to FIG. 3A-3D, the MVS 117 may access an image of an environment (e.g., environment 148) surrounding an aerial vehicle (e.g., aircraft 105). Because the aircraft 105 may operate in various environments the accessed images may reflect different objects germane to those environments. In other words, an accessed image may include a location of interest, an object of interest, etc. for the aircraft.

To contextualize, FIG. 3A-3D illustrates various locations of interest, according to several example embodiments. FIG. 3A illustrates an accessed image of a location of interest that is a landing strip, according to one example embodiment. FIG. 3B illustrates an accessed image of a location of interest that is a helipad, according to one example embodiment. FIG. 3C illustrates an accessed image of a location of interest that is a mountain, according to one example embodiment. FIG. 3D illustrates an accessed image of a dynamic object that is a hot air balloon.

Returning now to FIG. 2, the MVS 117 may apply 220 a SRM 152 to the image to determine information from the image. The information may include e.g., latent characteristics, a navigational state, and/or a state uncertainty based on latent information in the accessed image. The latent characteristics may include additional features and variables derivable from the image. The SRM 152 may also generate a reconstructed image using the determined latent characteristics, navigational state, and/or state uncertainty. The SRM 152 may be a model included in models 160 and trained by the training module 158 as described below.

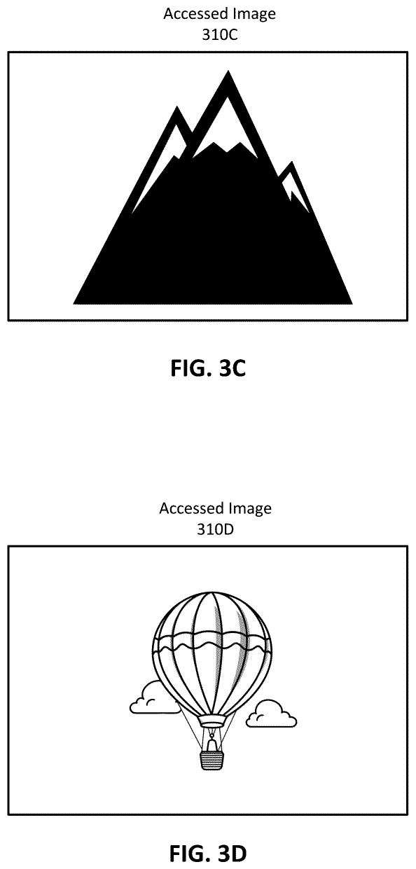

To illustrate, FIG. 4 shows an example workflow of a state recognition model, according to an example embodiment. As shown in FIG. 4, the SRM 152 accesses an accessed image 410 (or an accessed image 410 is input into the SRM 152). The accessed image 410 includes an array of pixels representing, e.g., a location or an object of interest. Additionally, latent information in the array of pixels of the accessed image 410 may represent various information that is derivable from the image. For instance, the pixels may include a navigational state or a state uncertainty for the aircraft relative to the object of interest derivable from the accessed image 410, and/or latent characteristics representing the location and/or object of interest in the accessed image 410.

The SRM 152 encodes the accessed image 410 into an encoder 420. The encoder 420 applies various functions having trained weights and parameters to the accessed image 410. As they are applied, the functions reduce the dimensionality of the accessed image 410 and identify information 430 in the accessed image 410 based on its pixel information. The information 430 represents various features derivable from the image. For instance, the MVS 117 may apply the SRM 152 to determine the navigational state of the aircraft using latent pixel information in the accessed image 410, and the MVS 117 may apply the SRM 152 to determine a state uncertainty for the aircraft using latent pixel information in the accessed image 410. Additionally, the MVS 117 may apply the SRM 152 to determine a class of the location of interest in the accessed image 410, the weather in the accessed image 410, lighting conditions in the accessed image 410, etc.

The SRM 152 decodes the information 430 using a decoder 440. The decoder 440 applies various functions having trained weights and parameters to the information 430 to generate the reconstructed image 450. As they are applied, the functions increase the dimensionality of the information 430/features to that of the reconstructed image 450 (or to less than that of the accessed image 410). The reconstructed image 450 may or may not be similar to the input accessed image 410 as described hereinbelow.

Additionally, the SRM 152 may output the information 430 (e.g., the navigational state and/or state uncertainty) in addition to generating the reconstructed image 450. The information 430 may be used by the PLM 154 to determine a navigational action for the aircraft as described hereinbelow.

Returning to FIG. 2, the MVS 117 may apply the SRM 152 to determine 230 whether the reconstructed image represents the location of interest.

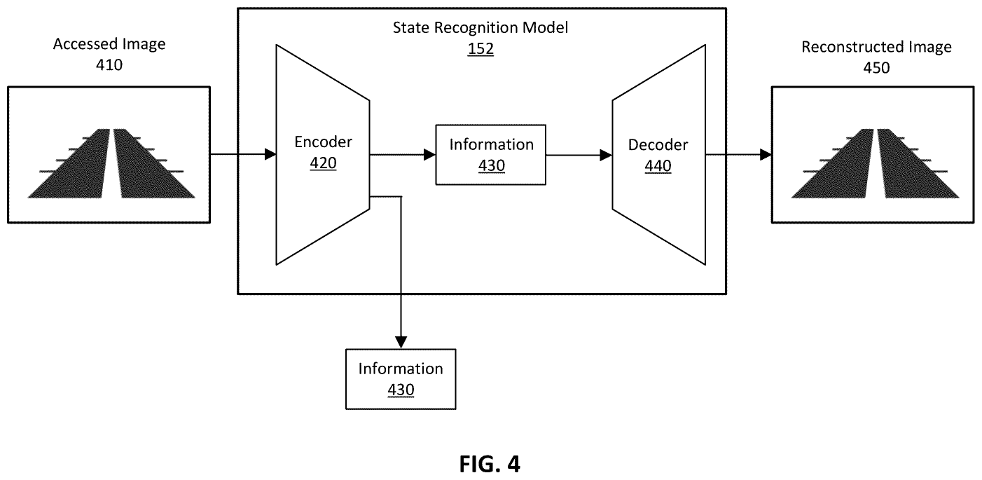

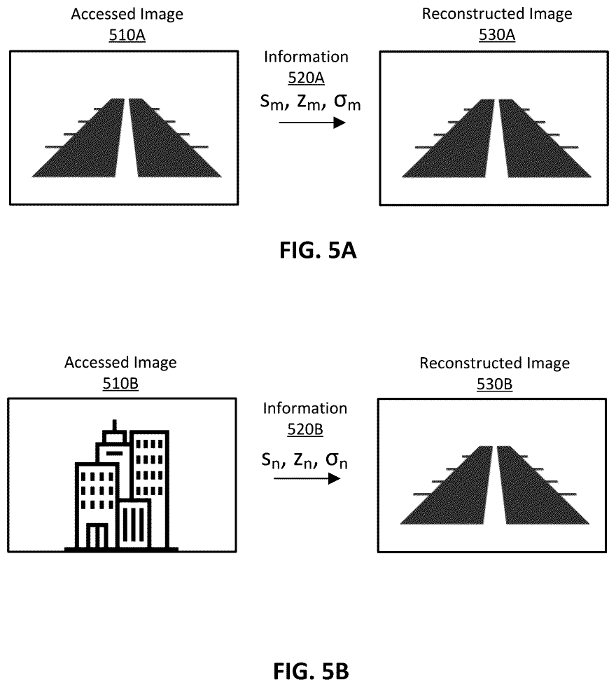

To illustrate, FIGS. 5A and 5B show a comparison of reconstructed image to its corresponding accessed image, according to an example embodiment.

In FIG. 5A, the MVS 117 applies the SRM 152 to an accessed image 510A, which determines information 520A including the navigational state sₘ, the state uncertainty zₘ, and other latent characteristics σₘ. The MVS 117 applies the SRM 152 to the information 520A to generate the reconstructed image 530A. The MVS 117 compares the generated image 530A to the accessed image 510A.

In FIG. 5A, a comparison of a reconstructed image to its corresponding accessed image results in an acceptable reconstructed image. An acceptable reconstructed image is one that is sufficiently similar to the accessed image from which it was generated. There are several methods to determine whether a reconstructed image is sufficiently similar to its corresponding accessed image. In a first method, the SRM 152 may calculate a distance metric quantifying the dissimilarities between the accessed image and the generated image. If the distance metric is below a threshold, the SRM 152 determines the reconstructed image is an acceptable reconstructed image (i.e., is sufficiently similar to the accessed image). Conversely, if the distance metric is above a threshold, the accessed image and the reconstructed image are not sufficiently similar. In a second method, the SRM 152 may apply a pixelwise comparison between the images. If a threshold number of the pixels are the same or a same class (e.g., 60%, 70%, 80%, 90%, etc.), then the SRM 152 determines the reconstructed image is an acceptable image. Conversely, if less than a threshold number of pixels are the same, then the accessed image and the reconstructed image are not sufficiently similar. If the MVS 117 determines that the reconstructed image is an acceptable image, it determines if the protection level indicates an operational system is available for a navigational action as discussed below (by passing images to the PLM to determine the protection level as described for the PLM 154).

Similarly, in FIG. 5B The MVS 117 applies the SRM 152 to an accessed image 510B, which determines information 520B including the navigational state sₙ, the state uncertainty zₙ, and other latent characteristics σₙ. The MVS 117 applies the SRM 152 to the information 520B to generate the reconstructed image 530B. The MVS 117 compares the generated image 530B to the accessed image 510B. However, in FIG. 5B, a comparison of a reconstructed image to its corresponding accessed image results in an unacceptable reconstructed image. An unacceptable reconstructed image is one that is not sufficiently similar to the accessed image from which it was generated. If the MVS 117 determines that the reconstructed image is an unacceptable image, the MVS 117 determines the operational system is unavailable and will not determine a navigational action.

Returning to FIG. 2, the MVS 117 applies 240 a protection model to the acceptable image to determine a protection level. More specifically, the MVS 117 will proceed to determine a protection level based on the accessed image if the reconstructed image is sufficiently similar to the accessed image (i.e., it is an acceptable image), but will not proceed to determine a protection level if the reconstructed image is not sufficiently similar to the accessed image (i.e., it is not an acceptable image). That is, if the MVS determines the accessed image and the reconstructed image are sufficiently similar, an operational system may be available subject to the determination made by the protection level model as described below. Conversely, if the MVS 117 determines the accessed image and the reconstructed image are not sufficiently similar, the MVS 117 determines the operational system is unavailable and will not determine a navigational action for that operational system.

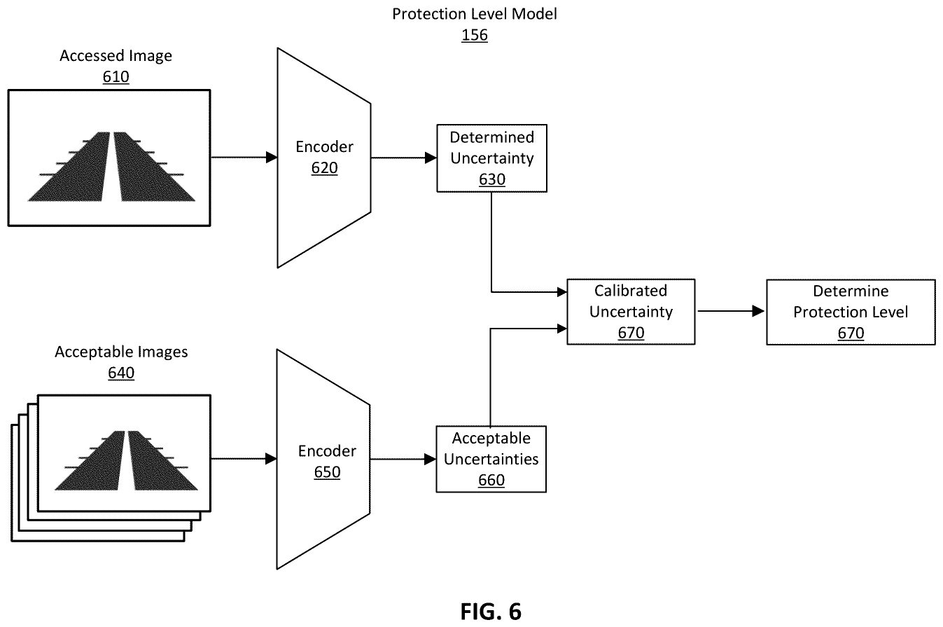

To illustrate, FIG. 6 depicts a workflow of a protection level model, according to an example embodiment. A PLM 154 encodes an accessed image 610 using an encoder 620 and outputs a determined uncertainty 630. A determined uncertainty may be the state uncertainty as described hereinabove. The determined uncertainties 630 may be used to recalibrate the uncertainty using previously determined acceptable uncertainties 660. In some example embodiments, the PLM 154 may access previously derived information from SRM 152 (e.g., information 430), rather than applying an encoder 620 to the accessed image 610.

To determine acceptable uncertainties 660, the PLM 154 uses a set of acceptable images 640. Acceptable images are images that are previously determined (i.e. labelled) to pass the availability check performed by comparing the accessed and reconstructed image in the SRM 152. The PLM 154 applies an encoder 650 to the acceptable images 640 to determine their navigational states and state uncertainties. In other words, the acceptable images are used to generate dataset of navigational states and state uncertainties that can be used to calibrate a measured navigational state and state uncertainty such that the measured navigational state and state uncertainty can be used to determine if an operational system is available. With this context, the dataset may include a range of navigational states and a range of state uncertainties (or some other description and/or quantification of the navigational states and navigational uncertainties) that, in aggregate, can be used to calibrate a measured navigational state.

Notably, the acceptable images 640 may be previously captured images labelled by a human operator, may be a simulated image based on previously captured acceptable images, or may be a reconstructed image from an accessed image of a location of interest. Additionally, the acceptable images typically represent a similar location of interest when generating acceptable uncertainties. For instance, the acceptable images may all portray a runway such that the acceptable uncertainties are associated with a runway, or the acceptable images may all portray a helipad such that the acceptable uncertainties are associated with the helipad. In this manner, if the SRM 152 is configured to identify a class of the location of interest, it may select the appropriate acceptable uncertainties for the identified class.

The PLM 154 then recalibrates the uncertainty of the aircraft using the determined uncertainty 630 and the acceptable uncertainties 660. Again, the determined uncertainty 630 may be the state uncertainty derived by the SRM 152, and the acceptable uncertainties 660 are the acceptable state uncertainties derived from acceptable images 640. To recalibrate the uncertainty, the PLM 154 determines a calibration factor from the acceptable uncertainties. The determined calibration factor may be, e.g., a conformal prediction determined from the acceptable uncertainties, but could be other calibration factors. The PLM 154 then applies the calibration factor to the determined uncertainty 630 to calculate the calibrated uncertainty 670. More simply, the calibrated uncertainty 670 is a determined uncertainty 630 that has been adjusted based on previous measurements (e.g., acceptable uncertainties 660). The calibrated uncertainty 670 is used to determine 680 the protection level of the navigation state of the aircraft.

Referring again to FIG. 2, the MVS 117 performs a navigational action on the navigational state. Generally, the performed navigational action is based on the determined protection level (e.g., at step 680). For instance, as described above, the MVS 117 may compare the determined protection level to an alert level (or threshold protection level) for the operational subsystem to determine if the subsystem is available or unavailable and perform a navigational action based on the determination of availability.

### V. Computer Vision Models

As described above, the machine vision subsystem 117 includes various modules that employ computer vision models 160 (e.g., the state recognition module employs a state recognition model, and protection level module employs a protection level model). The computer vision models may be one or more models 160 stored in the MVS 117. The computer vision models can have various structures. For instance, the computer vision models may be a convolutional neural network, a random forest, a support vector machine, a k-means cluster, a logistic regression, etc. Moreover, the MVS 117 includes a training module 156 to train the various models for their appropriate functionality (e.g., training a state recognition model to determine whether an image represents a location of interest).

### V. A Example Model Structure

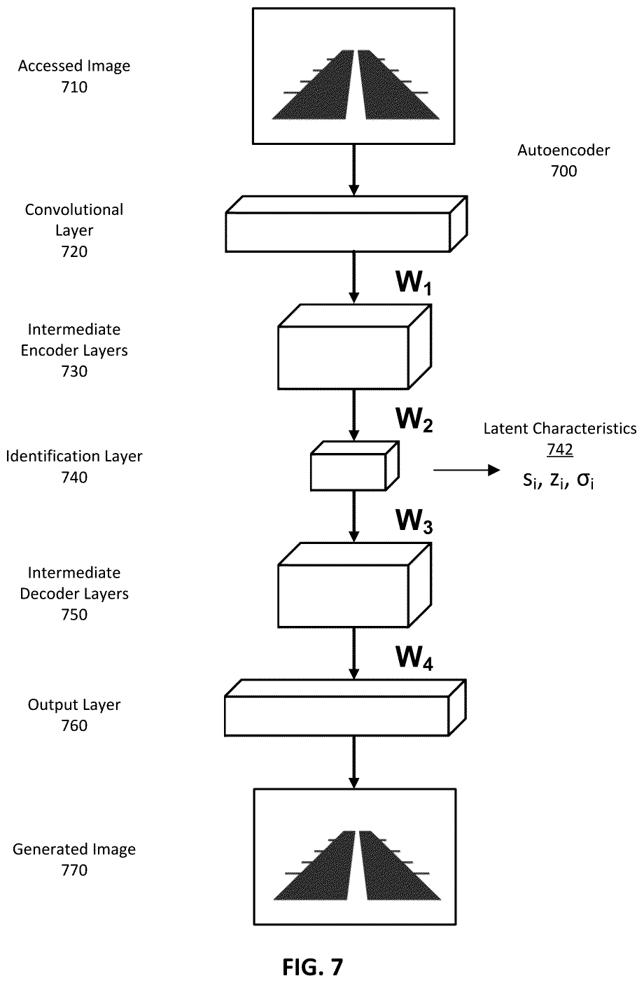

FIG. 7 illustrates a representation of an autoencoder model, according to an example embodiment. The autoencoder model 700 includes an encoder and decoder, and the encoder and decoder may be included in one or more of the models 158 stored in the MVS 117 (e.g., a state recognition model).

In the illustrated embodiment, the autoencoder model 700 is a convolutional neural network model with layers of nodes, in which values at nodes of a current layer are a transformation of values at nodes of a previous layer. A transformation in the model is determined through a set of weights and parameters connecting the current layer and the previous layer. For example, as shown in FIG. 7, the autoencoder model 700 includes five layers of nodes: layers 720, 730, 740, 750, and 760. The transformation from layer 720 to layer 730 is given by W₁, the transformation from layer 730 to layer 740 is given by W₂, the transformation from layer 740 to layer 750 is given by W₃, and the transformation from layer 750 to layer 760 is given by W₄.

The input to the model 700 is an accessed image 710 encoded onto the convolutional layer 720 and the output of the model is a generated image 770 decoded from the output layer 760. The model 700 identifies latent information in the accessed image including the navigational state the state uncertainty and other latent characteristics in the identification layer 740. The model 700 reduces of the dimensionality of the convolutional layer 720 to that of the identification layer 740 to identify the plants, and then increases the dimensionality of the identification layer 740 to generate a image 770.

The accessed image 710 is encoded to a convolutional layer 720. In one example, accessed image is directly encoded to the convolutional layer 720 because the dimensionality of the convolutional layer 720 is the same as the pixel dimensionality of the accessed image 710. In other examples, the accessed image 710 can be adjusted such that the dimensionality of the accessed image 710 is the same as the dimensionality of the convolutional layer 720.

Accessed images 710 in the convolutional layer 720 can be related to latent characteristics information in the identification layer 740. Relevance information between these elements can be retrieved by applying a set of transformations between the corresponding layers. Continuing with the example from FIG. 7, the convolutional layer 720 of the model 700 represents an encoded accessed image 710, and identification layer 740 of the model 700 represents latent characteristics information. Latent characteristics 742 in a given accessed image 710 may be identified by applying the transformations W₁ and W₂ to the pixel values of the accessed image 710 in the space of convolutional layer 720. The weights and parameters for the transformations may indicate relationships between information contained in the accessed image and the identification of a plant. For example, the weights and parameters can be a quantization of shapes, colors, etc. included in latent characteristics in an accessed image 710. The weights and parameters may be learned historical user interaction data including transformed images with identified latent characteristics (e.g., from labelled images).

Latent characteristics in the accessed image 710 are identified in the identification layer 740. The identification layer 740 is a data structure representing various information derivable from images captured by flight data subsystems (e.g., flight data subsystems 110). For instance, the information identified in the identification layer may be, e.g., a navigational state of an aircraft, a state uncertainty, additional latent characteristics for generating a generated image, and/or a class of a location or object of interest. The dimensionality of the identification layer 740 (i.e., the identification dimensionality) is based on an identification number. The identification number is the number (or combination) of features (e.g., types of information) that the identification layer 740 identifies in the accessed image 710.

Latent characteristics 742 identified in an accessed image 710 can be used to generate a image 770. To generate an image, the model 700 starts at the identification layer 740 and applies the transformations W₃ and W₄ to the value of the given latent characteristics 742 in the identification layer 740. The transformations result in a set of nodes in the output layer 760. The weights and parameters for the transformations may indicate relationships between an identified plants and a generated image 770. In some cases, the generated image 770 is directly output from the nodes of the output layer 750, while in other cases the control system decodes the nodes of the output layer 750 into a generated image 770.

Additionally, the model 700 can include layers known as intermediate layers. Intermediate layers are those that do not correspond to an accessed image 710, feature identification, or a generated image 770. For example, as shown in FIG. 7, layers 730 are intermediate encoder layers between the convolutional layer 720 and the identification layer 740. Layer 760 is an intermediate decoder layer between the identification layer 740 and the output layer 760. Hidden layers are latent representations of different aspects of a feature that are not observed in the data, but may govern the relationships between the elements of an image when identifying a plant. For example, a node in the hidden layer may have strong connections (e.g., large weight values) to input values and identification values that share the commonality of “left of center” or “too much altitude.” Specifically, in the example model of FIG. 7, nodes of the hidden layers 730 and 750 can link inherent information in the accessed image that share common characteristics to help determine if that information represents features of importance in the accessed image.

Additionally, each intermediate layer can represent a transformation function with its own specific weights and parameters. Any number of intermediate encoder layers 730 can function to reduce the convolutional layer to the identification layer and any number of intermediate decoder layers 750 can function to increase the identification layer 740 to the output layer 760. Alternatively stated, the encoder intermediate layers reduce the pixel dimensionality to the dimensionality of the identification layer, and the decoder intermediate layers increase the dimensionality of the identification layer to that of the generated image 770.

### VI. Example Computer System

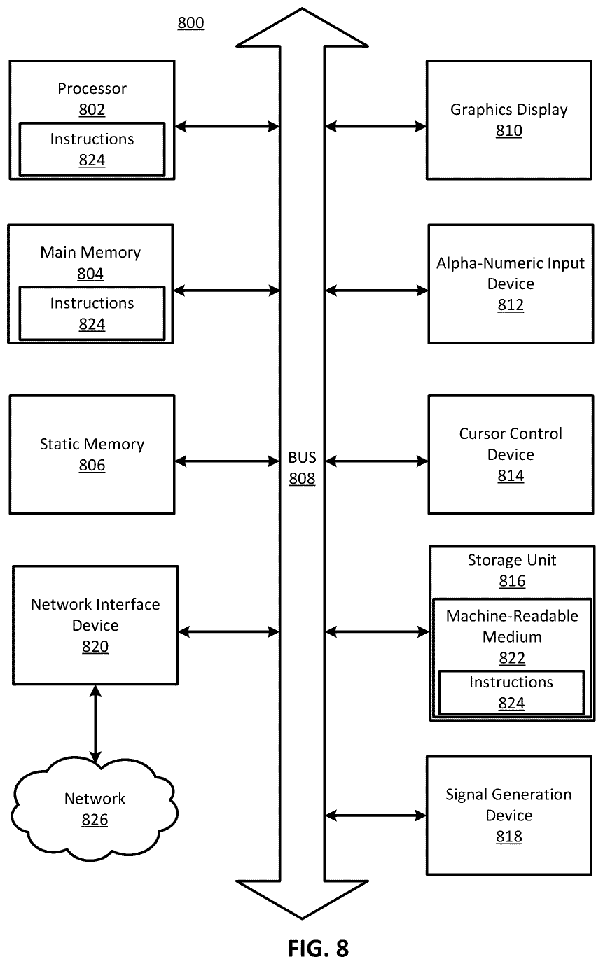

FIG. 8 is a block diagram illustrating components of an example machine for reading and executing instructions from a machine-readable medium, according to an example embodiment. Specifically, FIG. 1A shows a diagrammatic representation of a flight data subsystem 110 in the example form of a computer system 800. The computer system 800 can be used to execute instructions 824 (e.g., program code or software) for causing the machine to perform any one or more of the methodologies (or processes) described herein. In alternative embodiments, the machine operates as a standalone device or a connected (e.g., networked) device that connects to other machines.

The machine may be a server computer, a client computer, a personal computer (PC), a tablet PC, a set-top box (STB), a smartphone, an internet of things (IoT) appliance, a network router, switch or bridge, or any machine capable of executing instructions 824 (sequential or otherwise) that specify actions to be taken by that machine. Further, while only a single machine is illustrated, the term “machine” shall also be taken to include any collection of machines that individually or jointly execute instructions 824 to perform any one or more of the methodologies discussed herein.

The example computer system 800 includes one or more processing units (generally processor 802). The processor 802 is, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The computer system 800 also includes a main memory 804. The computer system may include a storage unit 816. The processor 802, memory 804, and the storage unit 816 communicate via a bus 808.

In addition, the computer system 800 can include a static memory 806, a graphics display 810 (e.g., to drive a plasma display panel (PDP), a liquid crystal display (LCD), or a projector). The computer system 800 may also include alphanumeric input device 812 (e.g., a keyboard), a cursor control device 814 (e.g., a mouse, a trackball, a joystick, a motion sensor, or other pointing instrument), a signal generation device 818 (e.g., a speaker), and a network interface device 820, which also are configured to communicate via the bus 808.

The storage unit 816 includes a machine-readable medium 822 on which is stored instructions 824 (e.g., software) embodying any one or more of the methodologies or functions described herein. For example, the instructions 824 may include the functionalities of modules of the system 100 described in FIG. 1A. The instructions 824 may also reside, completely or at least partially, within the main memory 804 or within the processor 802 (e.g., within a processor's cache memory) during execution thereof by the computer system 800, the main memory 804 and the processor 802 also constituting machine-readable media. The instructions 824 may be transmitted or received over a network 826 via the network interface device 820.

While machine-readable medium 822 is shown in an example embodiment to be a single medium, the term “machine-readable medium” should be taken to include a single medium or multiple media (e.g., a centralized or distributed database, or associated caches and servers) able to store the instructions 824. The term “machine-readable medium” shall also be taken to include any medium that is capable of storing instructions 824 for execution by the machine and that cause the machine to perform any one or more of the methodologies disclosed herein. The term “machine-readable medium” includes, but not be limited to, data repositories in the form of solid-state memories, optical media, and magnetic media.

### VII. Additional Considerations

In the description above, for purposes of explanation, numerous specific details are set forth in order to provide a thorough understanding of the illustrated system and its operations. It will be apparent, however, to one skilled in the art that the system can be operated without these specific details. In other instances, structures and devices are shown in block diagram form in order to avoid obscuring the system.

Reference in the specification to “one embodiment” or “an embodiment” means that a particular feature, structure, or characteristic described in connection with the embodiment is included in at least one embodiment of the system. The appearances of the phrase “in one embodiment” in various places in the specification are not necessarily all referring to the same embodiment.

Some portions of the detailed descriptions are presented in terms of algorithms or models and symbolic representations of operations on data bits within a computer memory. An algorithm is here, and generally, conceived to be steps leading to a desired result. The steps are those requiring physical transformations or manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Some of the operations described herein are performed by a computer physically mounted within a system (e.g., system 100). This computer may be specially constructed for the required purposes, or it may comprise a general-purpose computer selectively activated or reconfigured by a computer program stored in the computer. Such a computer program may be stored in a compute-readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of non-transitory computer-readable storage medium suitable for storing electronic instructions.

The figures and the description above relate to various embodiments by way of illustration only. It should be noted that from the following discussion, alternative embodiments of the structures and methods disclosed herein will be readily recognized as viable alternatives that may be employed without departing from the principles of what is claimed.

One or more embodiments have been described above, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct physical or electrical contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article or apparatus that comprises a list of elements is not necessarily limited to only those elements but may include other elements not expressly listed or inherent to such process, method, article or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B is true (or present).

In addition, use of the “a” or “an” are employed to describe elements and components of the embodiments herein. This is done merely for convenience and to give a general sense of the system. This description should be read to include one or at least one and the singular also includes the plural unless it is obvious that it is meant otherwise.

Upon reading this disclosure, those of skill in the art will appreciate still additional alternative structural and functional designs for the disclosed system. Thus, while particular embodiments and applications have been illustrated and described, it is to be understood that the disclosed embodiments are not limited to the precise construction and components disclosed herein. Various modifications, changes and variations, which will be apparent to those, skilled in the art, may be made in the arrangement, operation and details of the method and apparatus disclosed herein without departing from the spirit and scope defined in the appended claims.

What is claimed is:

1. A method comprising:
accessing an image of an environment surrounding an aerial vehicle, the image comprising latent pixel information;
applying a state recognition model to the image to determine whether the image represents a location of interest, the state recognition model configured to:
determine a navigational state of the aerial vehicle using latent pixel information of the image,
determine an uncertainty of the navigational state using latent pixel information of the image,
generate a reconstructed image using the navigational state and the uncertainty, and
compare the image to the reconstructed image to determine whether the image represents the location of interest;
responsive to determining the image represents the location of interest, applying a protection model to the image to determine a protection level for the aerial vehicle based on the uncertainty; and
performing, with the aerial vehicle, a navigation action based on the navigational state when the protection level is below a threshold protection level.

2. The method of claim 1, wherein the latent pixel information comprises information representing the location of interest, the navigational state of the aerial vehicle, and the uncertainty of the navigational state.

3. The method of claim 1, wherein determining the image represents the location of interest with the state recognition model further comprises:
identifying additional latent variables representing the location of interest using the latent pixel information;
wherein generating the reconstructed image additionally uses the additional latent variables.

4. The method of claim 1, wherein comparing the image to the reconstructed image comprises calculating a distance metric quantifying differences between the image and the reconstructed image.

5. The method of claim 1, wherein accessing the image of the environment comprises:
capturing an image of the environment using an camera system of the aerial vehicle.

6. The method of claim 1, wherein determining the protection level using the protection model comprises:
calibrating an actual uncertainty based on the uncertainty and a dataset of navigational states and state uncertainties, the dataset previously calculated from a plurality of acceptable images.

7. The method of claim 1, wherein the location of interest comprises any one of:
a runway,
a landing pad,
a dynamic object surrounding the aerial vehicle, and
a static object surrounding the aerial vehicle.

8. The method of claim 7, wherein the runway comprises one or more of:
an approach light system,
a runway threshold,
runway threshold markings,
runway end identifier lights,
a slope indicator,
a touchdown zone,
touchdown zone lights,
runway markings, and
runway lights.

9. The method of claim 1, wherein the aerial vehicle comprises any one of:
an autonomously controlled aerial vehicle,
a semi-autonomously controlled aerial vehicle,
a remote-controlled aerial vehicle,
a drone,
a helicopter,
a glider,
a rotorcraft,
a lighter than air vehicle,
a powered lift vehicle, and
an airplane.

10. The method of claim 1, wherein the threshold protection level is implemented by a system designer of the protection model.

11. The method of claim 1, wherein each protection level corresponds to a range of uncertainties for the navigational state.

12. The method of claim 1, wherein the determined uncertainty is an aleatoric uncertainty.

13. The method of claim 1, wherein the protection level is associated with a system of the aerial vehicle, and the system performs the navigation action.

14. The method of claim 1, wherein the state recognition model is trained using a plurality of training images, the plurality of training images comprising real images, simulated images, or a combination of real and simulated images.

15. The method of claim 14, wherein each training image of the plurality comprises latent pixel information representing a similar location of interest and an acceptable navigational state and an acceptable uncertainty of the navigational state.

16. The method of claim 1, wherein each protection level corresponds to a range of uncertainties for the navigational state.

17. The method of claim 1, wherein the determined uncertainty is an aleatoric uncertainty.

18. The method of claim 1, wherein the protection level is associated with a system of the aerial vehicle, and the system performs the navigation action.

19. A method comprising:
at a computer system comprising a processor and a computer-readable medium:
accessing an image of an environment surrounding an aerial vehicle, the image comprising latent pixel information;
applying a state recognition model to the image to determine whether the image represents a location of interest, the state recognition model configured to:
determine a navigational state of the aerial vehicle using latent pixel information of the image,
determine an uncertainty of the navigational state using latent pixel information of the image,
generate a reconstructed image using the navigational state and the uncertainty, and
compare the image to the reconstructed image to determine whether the image represents the location of interest;
responsive to determining the image represents the location of interest, applying a protection model to the image to determine a protection level for the aerial vehicle based on the uncertainty; and
performing, with the aerial vehicle, a navigation action based on the navigational state when the protection level is below a threshold protection level.

20. A non-transitory, computer-readable medium storing instructions that, when executed by a processor, cause the processor to:
access an image of an environment surrounding an aerial vehicle, the image comprising latent pixel information;
apply a state recognition model to the image to determine whether the image represents a location of interest, the state recognition model configured to:
determine a navigational state of the aerial vehicle using latent pixel information of the image,
determine an uncertainty of the navigational state using latent pixel information of the image,
generate a reconstructed image using the navigational state and the uncertainty, and
compare the image to the reconstructed image to determine whether the image represents the location of interest;
responsive to determine the image represents the location of interest, applying a protection model to the image to determine a protection level for the aerial vehicle based on the uncertainty; and
perform with the aerial vehicle, a navigation action based on the navigational state when the protection level is below a threshold protection level.
